(19) United States
(12) Patent Application Publication
(10) Pub. No.: US 2006/0126854 A1
(43) Pub. Date: Jun. 15, 2006

(54) Acoustic apparatus

(75) Inventor: Ryuichiro Noto, Saitama (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/297,559

(22) Filed: Dec. 8, 2005

(30) Foreign Application Priority Data
Dec. 10, 2004 (JP) 2004-358581

(51) Int. Cl. H04R 5/00

(52) U.S. Cl. 381/19; 381/18; 381/123

(57) ABSTRACT

An acoustic apparatus includes a plurality of speakers that is arranged in predetermined individual positions; a plurality of sound sources that sends respective independent audio signals; an audio signal processing unit that sends sound field generation signals of a plurality of channels based on an audio signal supplied from a sound source selected from among the plurality of sound sources; and an audio signal supply switching unit that supplies to the plurality of speakers the sound field generation signals of the plurality of channels acquired from the audio signal processing unit and that switches a mode of supplying the sound field generation signals of the plurality of channels to the plurality of speakers in accordance with the selection of the sound source for supplying the audio signal to the audio signal processing unit from among the plurality of sound sources.

### CROSS-REFERENCES TO RELATED APPLICATIONS

The present invention contains subject matter related to Japanese Patent Application JP 2004-358581 filed in the Japanese Patent Office on Dec. 10, 2004, the entire contents of which are incorporated herein by reference.

### BACKGROUND OF THE INVENTION

The present invention relates to an acoustic apparatus that generates a sound field by supplying sound field generation signals of a plurality of channels to a plurality of speakers arranged in individual positions.

For example, a technology for generating a surround sound field that provides an increased feeling of presence to an audience in a hall space by arranging a plurality of speakers in individual positions in the hall space and by supplying sound field generation signals of a plurality of channels, which are, for example, a left audio signal, a right audio signal, a surround left audio signal, and a surround right audio signal, to the plurality of speakers is known. Such a surround sound field is generated, for example, to display an image using an image display device, such as a television receiver, a video projector, or a video monitor, and to play back sound corresponding to the image displayed by the image display device.

When such a surround sound field is generated to play back sound corresponding to an image displayed by an image display device, a predetermined relationship is provided among the position and direction of a display screen of the image display device, the positions of a plurality of speakers used for generating the surround sound field, sound field generation signals of a plurality of channels supplied to the plurality of speakers. Normally, the display screen of the image display device is arranged in a position facing an audience who views the image displayed by the image display device and listens to the sound played back in the surround sound field, and the plurality of speakers is arranged around the position of the audience. The sound field generation signals of the plurality of channels are supplied to the plurality of speakers such that, for example, a left audio signal is supplied to a speaker arranged in the left front of the audience, a right audio signal is supplied to a speaker arranged in the right front of the audience, a surround left audio signal is supplied to a speaker arranged in the left rear of the audience, and a surround right audio signal is supplied to a speaker arranged in the right rear of the audience.

A configuration in which a plurality of image display devices is arranged in positions and an image corresponding to sound played back in a surround sound field is displayed by each of the plurality of image display devices is often available. In such a configuration, when an audience who faces a display screen of an image display device from among the plurality of image display devices and is viewing an image displayed by the image display device turns over to face a display screen of another image display device from among the plurality of image display devices and to view an image displayed by the other image display device, a mode of supplying the sound field generation signals of the plurality of channels to the plurality of speakers needs to be changed. In other words, for the audience who faces the display screen of the other image display device, for example, a left audio signal, a right audio signal, a surround left audio signal, and a surround right audio signal need to be supplied to a speaker arranged in the left front of the audience, to a speaker arranged in the right front of the audience, to a speaker arranged in the left rear of the audience, and to a speaker arranged in the right rear of the audience, respectively.

In relation to this, an audio-video apparatus (audio-visual (AV) apparatus) including two monitor televisions whose display screens face each other and a plurality of speakers arranged in individual positions and playing back sound corresponding to an image displayed by each of the two monitor televisions in a surround sound field is described, for example, in Japanese Unexamined Patent Application Publication No. 2001-128283. The audio-video apparatus switches sound field generation signals of a plurality of channels supplied to the plurality of speakers depending on whether an audience who is located between the display screens of the two image display devices is viewing an image displayed on one of the monitor televisions or an image displayed on the other one of the monitor televisions.

Such an audio-video apparatus includes, in addition to the two monitor televisions and the plurality of speakers, an AV center controller and a signal supply circuit unit that supplies the sound field generation signals of the plurality of channels to the plurality of speakers. The signal supply circuit unit includes a plurality of selection switches for switching the sound field generation signals of the plurality of channels supplied to the plurality of speakers. The plurality of selection switches is switched by operating the AV center controller depending on whether an audience faces a display screen of one of the monitor televisions and views an image displayed by the one of the monitor televisions or faces a display screen of the other one of the monitor televisions and views an image displayed by the other one of the monitor televisions, so that the mode of supplying the sound field generation signals of the plurality of channels to the plurality of speakers is changed. In this case, the sound field generation signals of the plurality of channels are, for example, a front left channel audio signal, a surround left channel audio signal, a front right channel audio signal, a surround right channel audio signal, a center audio signal, and a subwoofer audio signal.

### SUMMARY OF THE INVENTION

The above-described audio-video apparatus generates a surround sound field by supplying to a plurality of speakers sound field generation signals of a plurality of channels that are obtained in accordance with an audio signal from a sound source and that correspond to an image displayed on each of two monitor televisions. In contrast, for example, a case where a plurality of sound sources sending respective independent audio signals is provided, a sound source is selected from among the plurality of sound sources, sound field generation signals of a plurality of channels acquired in accordance with the corresponding audio signal from the selected sound source are supplied to a plurality of speakers, and a surround sound field corresponding to the selected sound source is generated is also considered.

This case is applied, for example, to a video-audio system in which a plurality of image display devices each displaying an image based on a supplied independent video signal is arranged in individual positions, a plurality of speakers shared among the plurality of image display devices is arranged in individual positions, and sound corresponding to an image displayed by any image display device from among the plurality of image display devices is played back in a surround sound field generated using the plurality of speakers. Such a video-audio system includes a plurality of sound sources sending respective independent audio signals corresponding to a video signal supplied to each of the plurality of image display devices. A sound source is selected from among the plurality of sound sources in accordance with selection of an image display device for displaying an image, a surround sound field is generated by supplying to the plurality of speakers sound field generation signals of a plurality of channels acquired in accordance with the corresponding audio signal from the selected sound source, and sound corresponding to the image displayed by the selected image display device is played back.

In a case where a sound source is selected from among a plurality of sound sources sending respective independent audio signals, sound field generation signals of a plurality of channels acquired in accordance with the corresponding audio signal from the selected sound source are supplied to a plurality of speakers, and a surround sound field corresponding to the selected sound source is generated, for example, a mode of supplying the sound field generation signals of the plurality of channels to the plurality of speakers needs to be switched in accordance with the selection of the sound source based on the selection of an image display device for displaying an image viewed by an audience from among the plurality of image display devices. This is because sound field generation signals of a plurality of channels supplied to a plurality of speakers are used for playing back sound corresponding to an image displayed by a selected image display device and the direction of an audience is changed in accordance with the selected image display device.

Thus, an apparatus is desired in which, when a sound source is selected from among a plurality of sound sources, sound field generation signals of a plurality of channels acquired in accordance with an audio signal from the selected sound source are supplied to a plurality of speakers, and a surround sound field corresponding to the selected sound source is generated, the surround sound field is generated so as to be appropriate for an audience who listens to sound played back based on the audio signal from the selected sound source by switching a mode of supplying the sound field generation signals of the plurality of channels to the plurality of speakers in accordance with the selection of the sound source. However, such an apparatus has not been available and no document describing a technology related to such an apparatus is available.

Accordingly, it is desirable to provide an acoustic apparatus in which, when a sound source is selected from among a plurality of sound sources sending respective independent audio signals, sound field generation signals of a plurality of channels acquired in accordance with the corresponding audio signal from the selected sound source are supplied to a plurality of speakers, and a surround sound field corresponding to the selected sound source is generated, the surround sound field is generated so as to be appropriate for an audience who listens to playback sound based on the audio signal from the selected sound source by switching a mode of supplying the sound field generation signals of the plurality of channels to the plurality of speakers in accordance with the selection of the sound source and in which addition or deletion of a sound source can be readily performed.

An acoustic apparatus according to an embodiment of the present invention includes a plurality of speakers that is arranged in predetermined individual positions, a plurality of sound sources that sends respective independent audio signals, an audio signal processing unit that sends sound field generation signals of a plurality of channels based on an audio signal supplied from a sound source selected from among the plurality of sound sources, and an audio signal supply switching unit that supplies to the plurality of speakers the sound field generation signals of the plurality of channels acquired from the audio signal processing unit and that switches a mode of supplying the sound field generation signals of the plurality of channels to the plurality of speakers in accordance with the selection of the sound source for supplying the audio signal to the audio signal processing unit from among the plurality of sound sources.

For example, the acoustic apparatus includes the plurality of sound sources each provided in an image display device that displays an image based on a video signal and each sending an audio signal corresponding to the displayed image. For example, when a sound source is selected from among the plurality of sound sources in accordance with selection of an image display device for displaying an image, sound field generation signals of a plurality of channels based on the audio signal from the selected sound source are acquired from the audio signal processing unit, and the acquired sound field generation signals of the plurality of channels are supplied to the audio signal supply switching unit. The audio signal supply switching unit supplies the sound field generation signals of the plurality of channels to the plurality of speakers so that sound based on the audio signal from the selected sound source is played back in a surround sound field. At this time, a mode of supplying the sound field generation signals of the plurality of channels to the plurality of speakers is switched, according to need, in accordance with the selection of the sound source.

In the acoustic apparatus, the number of the plurality of speakers is, for example, four or more, the number of the plurality of channels for the sound field generation signals is, for example, four or more, and the sound field generation signals of four or more channels include, for example, a left audio signal, a right audio signal, a surround left audio signal, and a surround right audio signal.

According to the acoustic apparatus, when any sound source is selected from among the plurality of sound sources, a surround sound field appropriate for an audience who listens to playback sound based on an audio signal from the selected sound source can be generated. Thus, for example, in a case where the acoustic apparatus is used together with a plurality of image display devices each displaying an image based on a video signal, when the acoustic apparatus selects a sound source from among the plurality of sound sources in accordance with selection of an image display device for displaying an image, sound corresponding to the displayed image can be played back in a surround sound field appropriate for an audience who views the image displayed by the selected image display device and listens to playback sound based on an audio signal from the selected sound source.

In addition, in the acoustic apparatus, when playback sound based on an audio signal from a sound source selected from among the plurality of sound sources is played back in an appropriate surround sound field, the number of the plurality of sound sources is not a constraint condition. Thus, for example, addition or deletion of a sound source for sound playback can be readily performed by changing a state of connection of the sound source to the audio signal processing unit or changing setting of the audio signal processing unit and by changing setting of the audio signal supply switching unit.

### BRIEF DESCRIPTION OF THE DRAWINGS

FIG. 1 is a block connection diagram showing an example of the basic structure of an acoustic apparatus according to embodiments of the present invention;

FIG. 2 is a schematic diagram showing an example of the arrangement of units forming the acoustic apparatus shown in FIG. 1;

FIG. 3 is a schematic diagram for explaining an operation of the acoustic apparatus shown in FIG. 1;

FIG. 4 is a schematic diagram for explaining another operation of the acoustic apparatus shown in FIG. 1; and

FIG. 5 is a schematic diagram for explaining another operation of the acoustic apparatus shown in FIG. 1.

### DETAILED DESCRIPTION

Embodiments of the present invention will be described with reference to the drawings.

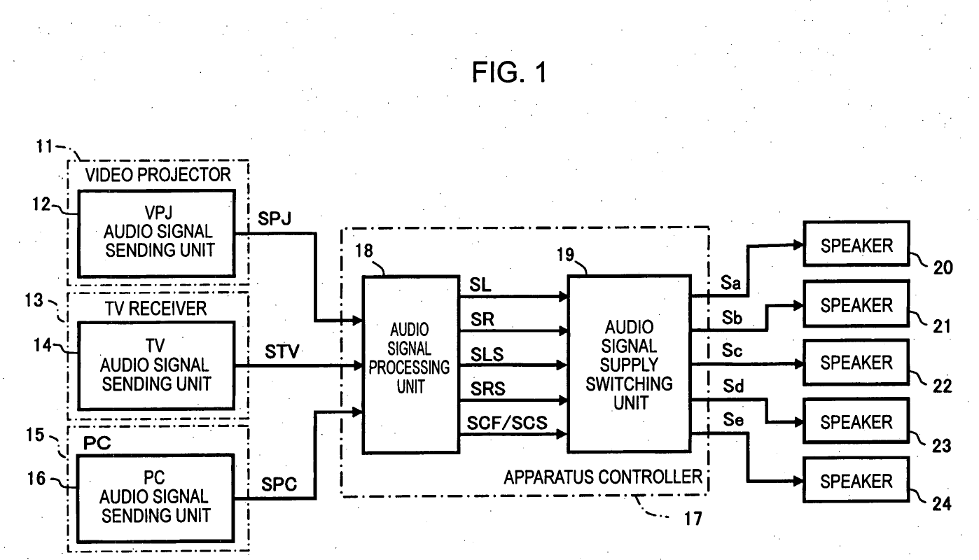

FIG. 1 shows an example of the basic structure of an acoustic apparatus according to the embodiments of the present invention.

Referring to FIG. 1, the acoustic apparatus includes a video projector (VPJ) audio signal sending unit 12 provided in a video projector 11, a television (TV) audio signal sending unit 14 provided in a TV receiver 13, and a personal computer (PC) audio signal sending unit 16 provided in a PC 15. The video projector 11, the TV receiver 13, and the PC 15 are image display devices that display images based on video signals. The VPJ audio signal sending unit 12 includes a sound source that sends an audio signal SPJ representing sound corresponding to an image projected and displayed on a screen by the video projector 11. The TV audio signal sending unit 14 includes a sound source that sends an audio signal STV representing sound corresponding to an image displayed on a display screen by the TV receiver 13. The PC audio signal sending unit 16 includes a sound source that sends an audio signal SPC representing sound corresponding to an image displayed on a display screen by the PC 15.

The audio signals SPJ, STV, and SPC acquired from the sound sources of the VPJ audio signal sending unit 12, the TV audio signal sending unit 14, and the PC audio signal sending unit 16, respectively, are supplied to an apparatus controller 17. The apparatus controller 17 includes an audio signal processing unit 18 and an audio signal supply switching unit 19.

The audio signals SPJ, STV, and SPC acquired from the VPJ audio signal sending unit 12, the TV audio signal sending unit 14, and the PC audio signal sending unit 16, respectively, are supplied to the audio signal processing unit 18. However, these audio signals SPJ, STV, and SPC are not supplied to the audio signal processing unit 18 at the same time. One of the VPJ audio signal sending unit 12, the TV audio signal sending unit 14, and the PC audio signal sending unit 16 is selected, and the audio signal SPJ, STV, or SPC from the selected VPJ audio signal sending unit 12, TV audio signal sending unit 14, or PC audio signal sending unit 16 is supplied to the audio signal processing unit 18. The audio signal processing unit 18 performs various types of processing including decoding for the audio signal SPJ, STV, or SPC, and acquires sound field generation signals of a plurality of channels based on the audio signal SPJ, STV, or SPC as, for example, a left audio signal SL, a right audio signal SR, a surround left audio signal SLS, a surround right audio signal SRS, and a front center signal SCF or a surround center signal SCS.

The left audio signal SL, the right audio signal SR, the surround left audio signal SLS, the surround right audio signal SRS, and the front center signal SCF or the surround center signal SCS acquired from the audio signal processing unit 18 are supplied to the audio signal supply switching unit 19. The audio signal supply switching unit 19 assigns the left audio signal SL, the right audio signal SR, the surround left audio signal SLS, the surround right audio signal SRS, and the front center signal SCF or the surround center signal SCS, which are sound field generation signals of a plurality of channels acquired from the audio signal processing unit 18, to a sound field generation signal Sa to be supplied to a speaker 20, a sound field generation signal Sb to be supplied to a speaker 21, a sound field generation signal Sc to be supplied to a speaker 22, a sound field generation signal Sd to be supplied to a speaker 23, and a sound field generation signal Se to be supplied to a speaker 24. The audio signal supply switching unit 19 of the apparatus controller 17 supplies the sound field generation signals Sa to Se to the speakers 20 to 24, respectively.

The audio signal supply switching unit 19 assigns the left audio signal SL, the right audio signal SR, the surround left audio signal SLS, the surround right audio signal SRS, and the front center signal SCF or the surround center signal SCS to the sound field generation signals Sa to Se such that the left audio signal SL is assigned to a sound field generation signal from among the sound field generation signals Sa to Se, the right audio signal SR is assigned to a sound field generation signal from among the sound field generation signals Sa to Se other than the sound field generation signal assigned for the left audio signal SL, the surround left audio signal SLS is assigned to a sound field generation signal from among the sound field generation signals Sa to Se other than the sound field generation signals assigned for the left audio signal SL and the right audio signal SR, and the surround right audio signal SRS is assigned to a sound field generation signal from among the sound field generation signals Sa to Se other than the sound field generation signals assigned for the left audio signal SL, the right audio signal SR, and the surround left audio signal SLS, and the front center signal SCF or the surround center signal SCS is assigned to a sound field generation signal from among the sound field generation signals Sa to Se other than the sound field generation signals assigned for the left audio signal SL, the right audio signal SR, the surround left audio signal SLS, and the surround right audio signal SRS.

The audio signal supply switching unit 19 switches, according to need, the relationship in assigning the left audio signal SL, the right audio signal SR, the surround left audio signal SLS, the surround right audio signal SRS, and the front center signal SCF or the surround center signal SCS to the sound field generation signals Sa to Se so as to correspond to the audio signal SPJ, STV, or SPC supplied to the audio signal processing unit 18, in other words, so as to correspond to selection of the VPJ audio signal sending unit 12, the TV audio signal sending unit 14, or the PC audio signal sending unit 16.

The sound field generation signals Sa to Se assigned for the left audio signal SL, the right audio signal SR, the surround left audio signal SLS, the surround right audio signal SRS, and the front center signal SCF or the surround center signal SCS and acquired from the audio signal supply switching unit 19 are supplied from the apparatus controller 17 to the speakers 20 to 24. As a result, a surround sound field based on the left audio signal SL, the right audio signal SR, the surround left audio signal SLS, the surround right audio signal SRS, and the front center signal SCF or the surround center signal SCS is generated by the speakers 20 to 24, and sound based on the audio signal SPJ, STV, or SPC supplied to the audio signal processing unit 18 is played back.

Accordingly, the audio signal supply switching unit 19 switches, according to need, the relationship in assigning the left audio signal SL, the right audio signal SR, the surround left audio signal SLS, the surround right audio signal SRS, and the front center signal SCF or the surround center signal SCS to the sound field generation signals Sa to Se so as to correspond to selection of the VPJ audio signal sending unit 12, the TV audio signal sending unit 14, or the PC audio signal sending unit 16. Thus, the audio signal supply switching unit 19 switches, according to need, a mode of supplying the left audio signal SL, the right audio signal SR, the surround left audio signal SLS, the surround right audio signal SRS, and the front center signal SCF or the surround center signal SCS, which are sound field generation signals, to the speakers 20 to 24 so as to correspond to the selection of the VPJ audio signal sending unit 12, the TV audio signal sending unit 14, or the PC audio signal sending unit 16 each including a sound source.

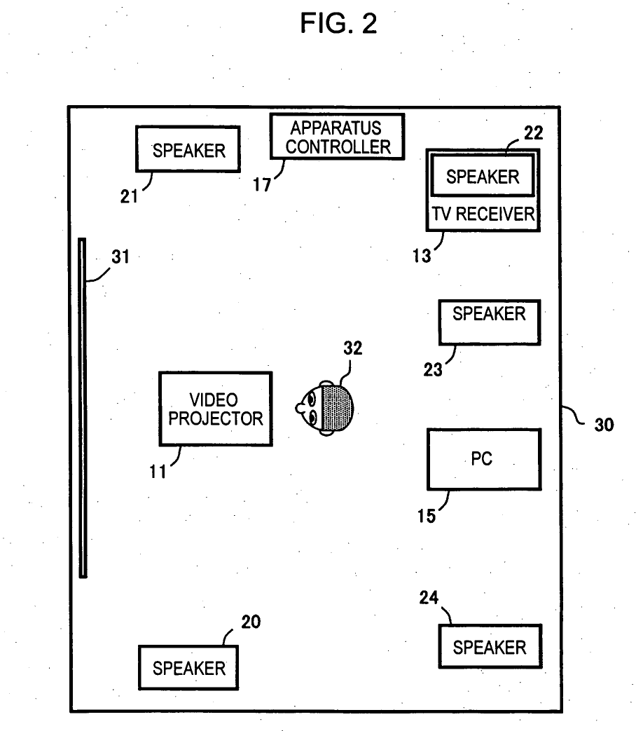

For example, the video projector 11, the TV receiver 13, the PC 15, the apparatus controller 17, and the speakers 20 to 24 of the acoustic apparatus shown in FIG. 1 are arranged in a hall space 30, as shown in FIG. 2. A screen 31 on which an image is projected and displayed by the video projector 11 is also arranged in the hall space 30. In addition, in the hall space 30, an audience 32 who views an image displayed by the video projector 11, the TV receiver 13, or the PC 15 and listens to sound played back in a surround sound field by the speakers 20 to 24 faces the screen 31, a display screen of the TV receiver 13, or a display screen of the PC 15. In FIG. 2, although the speakers 20, 21, 23, and 24 are provided as independent speakers, the speaker 22 is integrated with the TV receiver 13.

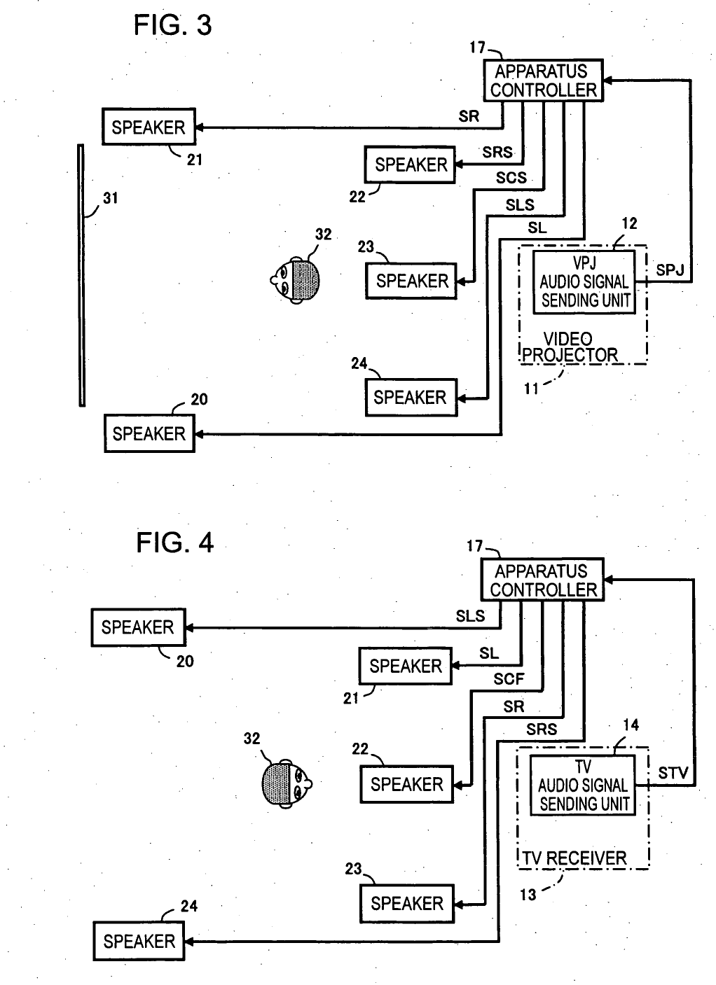

When the audience 32 selects the video projector 11 and faces the screen 31 in order to view an image projected and displayed on the screen 31 by the video projector 11 and to listen to sound corresponding to the image and played back in a surround sound field by the speakers 20 to 24 in the hall space 30, as shown in FIG. 3, an audio signal SPJ acquired from the VPJ audio signal sending unit 12 of the video projector 11 is supplied to the apparatus controller 17. The positions of the speakers 20 to 24 with respect to the audience 32 in terms of sound field generation are equivalently represented as shown in FIG. 3.

The audio signal processing unit 18 of the apparatus controller 17 generates a left audio signal SL, a right audio signal SR, a surround left audio signal SLS, a surround right audio signal SRS, and a surround center signal SCS, which are sound field generation signals of a plurality of channels, based on the audio signal SPJ. Then, the audio signal supply switching unit 19 of the apparatus controller 17 assigns the left audio signal SL, the right audio signal SR, the surround left audio signal SLS, the surround right audio signal SRS, and the surround center signal SCS acquired from the audio signal processing unit 18 to a sound field generation signal Sa, a sound field generation signal Sb, a sound field generation signal Se, a sound field generation signal Sc, and a sound field generation signal Sd, respectively, in accordance with the selection of the video projector 11. Thus, as shown in FIG. 3, the left audio signal SL is supplied to the speaker 20, the right audio signal SR is supplied to the speaker 22, the surround left audio signal SLS is supplied to the speaker 24, the surround right audio signal SRS is supplied to the speaker 22, and the surround center signal SCS is supplied to the speaker 23. As a result, a surround sound field based on the left audio signal SL, the right audio signal SR, the surround left audio signal SLS, the surround right audio signal SRS, and the surround center signal SCS is generated by the speakers 20 to 24 so as to be appropriate for the audience 32 who faces the screen 31, and sound based on the audio signal SPJ acquired from the VPJ audio signal sending unit 12 of the selected video projector 11 is played back.

When the audience 32 selects the TV receiver 13 and faces the display screen of the TV receiver 13 in order to view an image displayed on the display screen by the TV receiver 13 and to listen to sound corresponding to the image and played back in a surround sound field by the speakers 20 to 24 in the hall space 30, as shown in FIG. 4, an audio signal STV acquired from the TV audio signal sending unit 14 of the selected TV receiver 13 is supplied to the apparatus controller 17. The positions of the speakers 20 to 24 with respect to the audience 32 in terms of sound field generation are equivalently represented as shown in FIG. 4.

The audio signal processing unit 18 of the apparatus controller 17 generates a left audio signal SL, a right audio signal SR, a surround left audio signal SLS, a surround right audio signal SRS, and a front center signal SCF, which are sound field generation signals of a plurality of channels, based on the audio signal STV. Then, the audio signal supply switching unit 19 of the apparatus controller 17 assigns the left audio signal SL, the right audio signal SR, the surround left audio signal SLS, the surround right audio signal SRS, and the front center signal SCF acquired from the audio signal processing unit 18 to a sound field generation signal Sb, a sound field generation signal Sd, a sound field generation signal Sa, a sound field generation signal Se, and a sound field generation signal Sc, respectively, in accordance with the selection of the TV receiver 13. Thus, as shown in FIG. 4, the left audio signal SL is supplied to the speaker 21, the right audio signal SR is supplied to the speaker 23, the surround left audio signal SLS is supplied to the speaker 20, the surround right audio signal SRS is supplied to the speaker 24, and the front center signal SCF is supplied to the speaker 22. As a result, a surround sound field based on the left audio signal SL, the right audio signal SR, the surround left audio signal SLS, the surround right audio signal SRS, and the front center signal SCF is generated by the speakers 20 to 24 so as to be appropriate for the audience 32 who faces the display screen of the TV receiver 13, and sound based on the audio signal STV acquired from the TV audio signal sending unit 14 of the selected TV receiver 13 is played back.

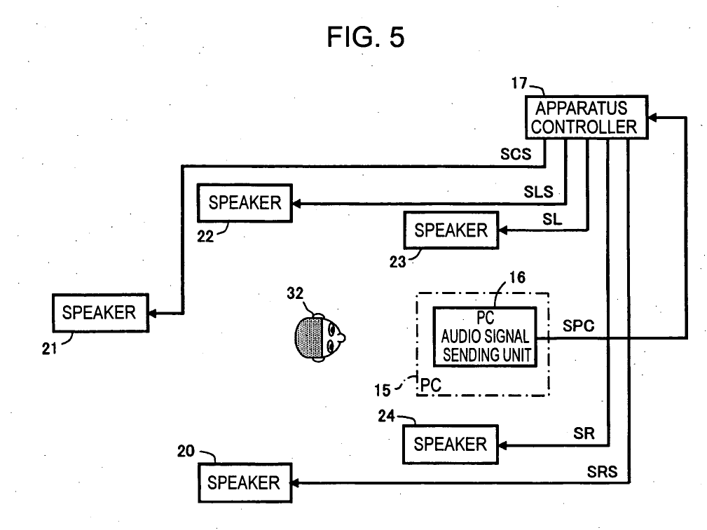

When the audience 32 selects the PC 15 and faces the display screen of the PC 15 in order to view an image displayed on the display screen by the PC 15 and to listen to sound corresponding to the image and played back in a surround sound field by the speakers 20 to 24 in the hall space 30, as shown in FIG. 5, an audio signal SPC acquired from the PC audio signal sending unit 16 of the selected PC 15 is supplied to the apparatus controller 17. The positions of the speakers 20 to 24 with respect to the audience 32 in terms of sound field generation are equivalently represented as shown in FIG. 5.

The audio signal processing unit 18 of the apparatus controller 17 generates a left audio signal SL, a right audio signal SR, a surround left audio signal SLS, a surround right audio signal SRS, and a surround center signal SCS, which are sound field generation signals of a plurality of channels, based on the audio signal SPC. Then, the audio signal supply switching unit 19 of the apparatus controller 17 assigns the left audio signal SL, the right audio signal SR, the surround left audio signal SLS, the surround right audio signal SRS, and the surround center signal SCS acquired from the audio signal processing unit 18 to a sound field generation signal Sd, a sound field generation signal Se, a sound field generation signal Sc, a sound field generation signal Sa, and a sound field generation signal Sb, respectively, in accordance with the selection of the PC 15. Thus, as shown in FIG. 5, the left audio signal SL is supplied to the speaker 23, the right audio signal SR is supplied to the speaker 24, the surround left audio signal SLS is supplied to the speaker 22, the surround right audio signal SRS is supplied to the speaker 20, and the surround center signal SCS is supplied to the speaker 21. As a result, a surround sound field based on the left audio signal SL, the right audio signal SR, the surround left audio signal SLS, the surround right audio signal SRS, and the surround center signal SCS is generated by the speakers 20 to 24 so as to be appropriate for the audience 32 who faces the PC 15, and sound based on the audio signal SPC from the PC audio signal sending unit 16 of the selected PC 15 is played back.

As described above, in the acoustic apparatus shown in FIG. 1, in a case where the video projector 11, the TV receiver 13, and the PC 15 are used, when one of the VPJ audio signal sending unit 12, the TV audio signal sending unit 14, and the PC audio signal sending unit 16 is selected in accordance with selection of one of the video projector 11, the TV receiver 13, and the PC 15, for an audience who views an image displayed by the selected one of the video projector 11, the TV receiver 13, and the PC 15 and listens to playback sound based on the audio signal SPJ, STV, or SPC acquired from the selected VPJ audio signal sending unit 12, TV receiver 13, or PC audio signal sending unit 16, the sound corresponding to the displayed image can be played back in an appropriate surround sound field.

Although the audio signal supply switching unit 19 is a single unit handling all the sound field generation signals Sa to Se of a plurality of channels in the acoustic apparatus shown in FIG. 1, the audio signal supply switching unit 19 may include a plurality of units handling the respective sound field generation signals Sa to Se of the plurality of channels.

It should be understood by those skilled in the art that various modifications, combinations, sub-combinations and alterations may occur depending on design requirements and other factors insofar as they are within the scope of the appended claims or the equivalents thereof.

1. An acoustic apparatus comprising:
a plurality of speakers that is arranged in predetermined individual positions;
a plurality of sound sources that sends respective independent audio signals;
an audio signal processing unit that sends sound field generation signals of a plurality of channels based on an audio signal supplied from a sound source selected from among the plurality of sound sources; and
an audio signal supply switching unit that supplies to the plurality of speakers the sound field generation signals of the plurality of channels acquired from the audio signal processing unit and that switches a mode of supplying the sound field generation signals of the plurality of channels to the plurality of speakers in accordance with the selection of the sound source for supplying the audio signal to the audio signal processing unit from among the plurality of sound sources.

2. The acoustic apparatus according to claim 1, wherein:
the number of the plurality of speakers is four or more; and
the number of the plurality of channels for the sound field generation signals is four or more.

3. The acoustic apparatus according to claim 2, wherein the sound field generation signals of four or more channels include a left audio signal, a right audio signal, a surround left audio signal, and a surround right audio signal.

4. The acoustic apparatus according to claim 2, wherein at least one of the plurality of sound sources functions as an audio signal sending unit in a video-audio device that displays an image and that plays back sound.

5. The acoustic apparatus according to claim 1, wherein the audio signal supply switching unit is a single unit that handles all the sound field generation signals of the plurality of channels.

6. The acoustic apparatus according to claim 1, wherein the audio signal supply switching unit includes a plurality of units that handles the respective sound field generation signals of the plurality of channels.
